(19) United States
(12) Patent Application Publication
(10) Pub. No.: US 2010/0019703 A1
(43) Pub. Date: Jan. 28, 2010

(54) Dual power supply type brushless fan motor speed control device

(76) Inventor: Hsien-Meng Lee, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/219,396

(22) Filed: Jul. 22, 2008

(51) Int. Cl. H02P 6/08

(52) U.S. Cl. 318/400.3

(57) ABSTRACT

A dual power supply type brushless fan motor speed control device for controlling the speed of the fan motor of a ceiling fan formed of a DC power supply circuit unit, a central processing unit, a medium and high speed power supply control unit, a low-speed power supply control unit, a back electromotive force detection circuit unit and three drive output control circuit units.

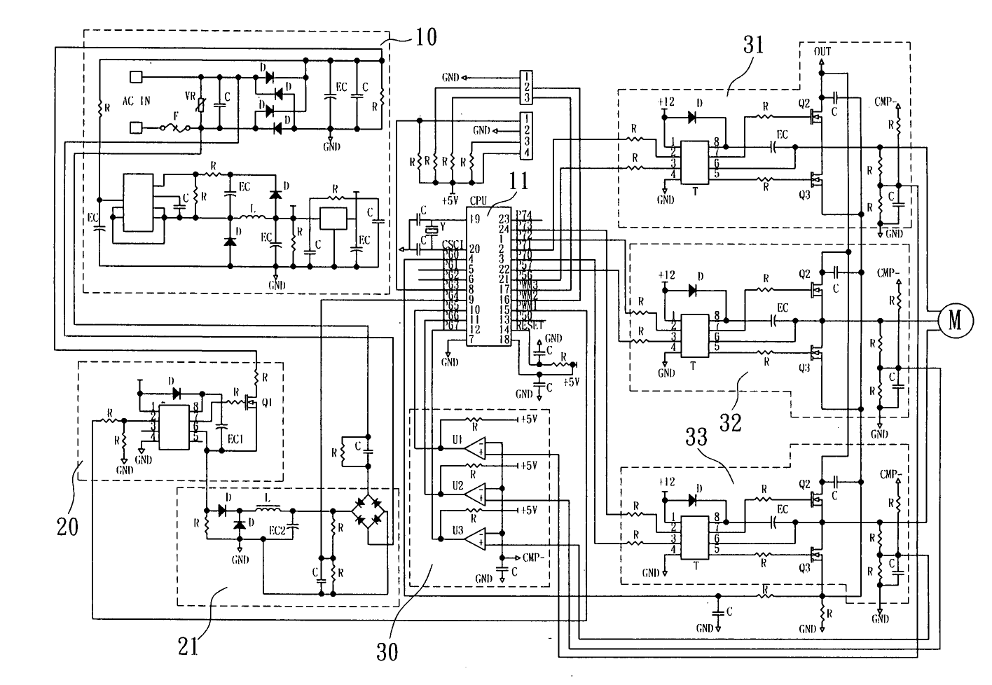

### BACKGROUND OF THE INVENTION

1. Field of the Invention

The present invention relates to ceiling fan technology and more specifically, to a dual power supply type brushless fan motor speed control device for controlling the speed of the fan motor of a ceiling fan.

2. Description of the Related Art

The speed of a conventional ceiling fan is controlled by means of pulse width modulation, i.e., changing the pulse width causes change of fan speed. This fan speed control method has drawbacks. For controlling the rotation at a low speed (50 rpm) subject to the magnetic attraction and repulsion principle of brushless motor, the fan motor must be stopped for a period and then started. During change from a rotation status to stop status or from stop status to a rotation status, the fan motor will vibrate, causing noise and generating waste heat.

### SUMMARY OF THE INVENTION

The present invention has been accomplished under the circumstances in view. It is one object of the present invention to provide a dual power supply type brushless fan motor speed control device for controlling the speed of the fan motor of a ceiling fan, which eliminates vibration and noise and does not generate much waste heat during a speed change. It is another object of the present invention to provide a dual power supply type brushless fan motor speed control device, which facilitates fabrication of the ceiling fan. To achieve these and other objects of the present invention, the dual power supply type brushless fan motor speed control device for controlling the speed of the fan motor of a ceiling fan is comprised of a DC power supply circuit unit, a central processing unit, a medium and high speed power supply control unit, a low-speed power supply control unit, a back electromotive force detection circuit unit and three drive output control circuit units.

### BRIEF DESCRIPTION OF THE DRAWINGS

The Figure is a circuit diagram of a dual power supply type brushless fan motor speed control device according to the preferred embodiment of the present invention.

### DETAILED DESCRIPTION OF THE PREFERRED EMBODIMENT

Referring to the Figure, a dual power supply type brushless fan motor speed control device in accordance with the present invention is shown comprised of a DC power supply circuit unit 10, a CPU (central processing unit) 11, a medium and high speed power supply control unit 20, a low-speed power supply control unit 21, a back electromotive force detection circuit unit 30, and three drive output control circuit units 31, 32 and 33.

The DC power supply circuit unit 10 rectifies AC power supply into stabilized DC power supply for the working of the whole circuit assembly and the motor M. The medium and high speed power supply control unit 20 and the low-speed power supply control unit 21 provide different voltages for the control of two different speeds. The back electromotive force detection circuit unit 30 is for rotor position detection for further control purpose. The drive output control circuit units 31, 32 and 33 are for signal amplification to rotate the motor M.

As illustrated in the Figure, the DC power supply circuit unit 10 has current rectification and voltage stabilization functions to convert AC into 12V, 5V and 150V DC power supply for the working of the whole circuit assembly and the motor M.

The CPU 11 has memorizing, computing, decoding and pulse width modulation functions, and is adapted to receive desired control signals and to output set control signals to the drive output control circuit units 31, 32 and 33.

The back electromotive force detection circuit unit 30 comprises three operation amplifiers U1, U2 and U3, and is electrically connected to the motor M and the CPU 11 to detect the position of the rotor of the motor M and to provide the detected data to the CPU 11 for further control.

The medium and high speed power supply control unit 20 is comprised of a field-effect power transistor Q1 and a capacitor EC1. The low-speed power supply control unit 21 is comprised of an inductor L and a capacitor EC2. The capacitor EC1 of the medium and high speed power supply control unit 20 and the capacitor EC2 of the low-speed power supply control unit 21 have different capacitance values for providing the motor M with a respective different working power.

The drive output control circuit units 31, 32 and 33 each comprise a power transistor T respectively electrically connected to the CPU 11, and field-effect power transistors Q2 and Q3 respectively electrically connected to the motor M.

The capacitor EC1 of the medium and high speed power supply control unit 20 and the capacitor EC2 of the low-speed power supply control unit 21 have different capacitance values. By means of capacitance reactance, the medium and high speed power supply control unit 20 and the low-speed power supply control unit 21 constitute a current-limit power supply circuit. When started the motor M, the CPU 11 outputs a simulated motor phase signal to the drive output control circuit units 31, 32 and 33 to control the positioning of the motor M. At this time, the operation amplifiers U1, U2 and U3 of the back electromotive force detection circuit unit 30 detect the rotor position of the motor M and provides the detected data to the CPU 11 for enabling the CPU 11 to drive the low-speed power supply control unit 21 in controlling rotation of the motor M at a low speed or the medium or to drive the high speed power supply control unit 20 in raising the speed subject to modulation ratio.

In details, for example, when at the first (low) speed, the capacitor EC2 of the low-speed power supply control unit 21 provides power to start rotation of the motor M at a low speed. When the second (medium) or third (high) speed is required, the field-effect power transistor Q1 of the medium and high speed power supply control unit 20 modulates the applied voltage at 12.5% per speed shift, causing the capacitor EC1 to output the relative necessary working power, achieving medium or high speed control.

In other words, when the motor M is at the low speed, only 50% of the voltage is necessary, and therefore the field-effect power transistor Q1 is regulated to provide 50% of the output. Because only 50% of the electric current is provided at this time, the temperature of the field-effect transistors Q2 and Q3 is reduced by 75%.

In general, the invention has the following advantages:

1. Low temperature: By means of the operation of the dual power supply of the medium and high speed power supply control unit 20 and the low-speed power supply control unit 21, the temperature of the field-effect power transistors is lowered, and the capacitors EC1 and EC2 are selectively controlled to provide power. Because capacitors do not generate waste heat during operation, the invention achieves a low temperature effect.

2. Low noise level: By means of the operation of the dual power supply of the medium and high speed power supply control unit 20 and the low-speed power supply control unit 21 to control motor speed, the motor rotates the fan blade smoothly without vibration, lowering the noise level.

3. Easy to fabrication: Different: capacitors EC1 and EC2 of different capacitance values can be selected to fit different sizes of fan blades or fan motors for different speed controls. Therefore, the invention facilitates inventory control and fabrication of ceiling fans, improving the productivity.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A dual power supply type brushless fan motor speed control device for controlling the speed of a fan motor, comprising: a DC power supply circuit unit, a central processing unit, a medium and high speed power supply control unit, a low-speed power supply control unit, a back electromotive force detection circuit unit, and three drive output control circuit units, wherein:
said DC power supply circuit unit rectifies AC power supply into stabilized 12V, 5V and 150V DC power supply for the working of said fan motor;
said central processing unit has memorizing, computing, decoding and pulse width modulation functions, and is adapted to receive control signals and to output set control signals to said drive output control circuit units;
said back electromotive force detection circuit unit comprises three operation amplifiers, and is electrically connected said fan motor and said central processing unit to detect the position of the rotor of said fan motor and to provide the detected data to said central processing unit for further control;
said medium and high speed power supply control unit and said low-speed power supply control unit constitute a current-limit power supply circuit, said medium and high speed power supply control unit being comprised of a field-effect power transistor and a capacitor, said low-speed power supply control unit being comprised of an inductor and a capacitor, the capacitor of said medium and high speed power supply control unit and the capacitor of said low-speed power supply control unit having different capacitance values for providing a respective working power to said fan motor;
said drive output control circuit units each comprise a power transistor respectively electrically connected to said central processing unit and field-effect power transistor means respectively electrically connected to said fan motor.
